(19) United States
(12) Patent Application Publication
(10) Pub. No.: US 2025/0037450 A1
(43) Pub. Date: Jan. 30, 2025

(54) IMAGE PROCESSING DEVICE

(71) Applicant: Mitsubishi Electric Corporation, Tokyo (JP)

(72) Inventors: Marie Kawai, Tokyo (JP); Masayoshi Tsuchida, Tokyo (JP); Satoshi Kageme, Tokyo (JP)

(73) Assignee: Mitsubishi Electric Corporation, Tokyo (JP)

(21) Appl. No.: 18/917,760

(22) Filed: Oct. 16, 2024

(51) Int. Cl. G06V 20/10; G06V 10/25

(52) U.S. Cl. CPC G06V 20/10; G06V 10/25

(57) ABSTRACT

An image processing device according to the technology of the present disclosure includes: a coherence calculation processing unit to calculate a coherence map; a threshold calculation processing unit to set a threshold used to extract a change region; a threshold processing unit to perform threshold processing using the threshold; and a change identification processing unit to identify, when it is determined that a change occurs in pixels of interest by the threshold processing on the basis of the coherence maps for at least three images, a type of the change.

### CROSS REFERENCE TO RELATED APPLICATION

This application is a Continuation of PCT International Application No. PCT/JP2022/022572, filed on Jun. 3, 2022, which is hereby expressly incorporated by reference into the present application.

### TECHNICAL FIELD

The technology according to the present disclosure relates to an image processing device.

### BACKGROUND ART

In general, image processing technologies related to radar images are known. More specifically, an image processing device is known that processes a radar image of a ground surface obtained by observation of a synthetic aperture radar that performs periodic observation.

For example, Patent Literature 1 discloses an image processing device that calculates a plurality of complex correlation distributions (coherence maps) from a plurality of radar images and extracts a physical change of the surface of the ground.

### CITATION LIST

### Patent Literatures

Patent Literature 1: JP 2009-289111 A

### SUMMARY OF INVENTION

### Technical Problem

The conventional image processing device disclosed in Patent Literature 1 uses coherences of only two adjacent radar images among radar images arranged in time series, and thus the obtained information is limited. In view of this, the technology according to the present disclosure utilizes information obtained from coherences of three radar images for the purpose of obtaining more information. An object of the technology according to the present disclosure is to achieve extraction of a physical change occurring on a ground surface included in a radar image with higher accuracy than before by improving a conventional image processing device as disclosed in Patent Literature 1.

### Solution to Problem

An image processing device according to the technology of the present disclosure includes: a coherence calculator to calculate a coherence map for all combinations of images, choosing two from the total number; a threshold calculator to set a threshold used to extract a change region; a threshold processor to perform threshold processing on the coherence map using the threshold; and a change identifier to determine which of at least nine different modes of coherence change occurs by referring to the coherence maps calculated by the coherence calculator for two combinations of images, two of which are extracted from at least three images, and to identify the type of change when it is determined that a change has occurred in the pixel of interest through the threshold processing.

The coherence calculator, when calculating coherence, uses a value obtained by spatially Fourier transforming L pixels centered on a position (y, x) in place of a data value (Zn(y, x)) at the position (y, x) in the radar image.

### Advantageous Effects of Invention

The image processing device according to the technology of the present disclosure has the above configuration, and thus, can extract a physical change occurred on the ground surface included in three radar images with higher accuracy than before by using information obtained from coherences of the radar images.

### BRIEF DESCRIPTION OF DRAWINGS

FIG. 1 is a block diagram illustrating a functional configuration of an image processing device according to a first embodiment.

FIG. 2 is a block diagram illustrating a functional configuration of a threshold calculation processing unit 110a included in the image processing device according to the first embodiment.

FIG. 3 is a block diagram illustrating a functional configuration of an image processing device according to a second embodiment.

FIG. 4 is a block diagram illustrating a functional configuration of a threshold calculation processing unit 110b included in the image processing device according to the second embodiment.

FIG. 5 is a block diagram illustrating a functional configuration of an image processing device according to a third embodiment.

FIG. 6 is a block diagram illustrating a functional configuration of an image processing device according to a fourth embodiment.

FIG. 7 is a block diagram illustrating a functional configuration of a threshold calculation processing unit 110d included in the image processing device according to the fourth embodiment.

### DESCRIPTION OF EMBODIMENTS

### First Embodiment

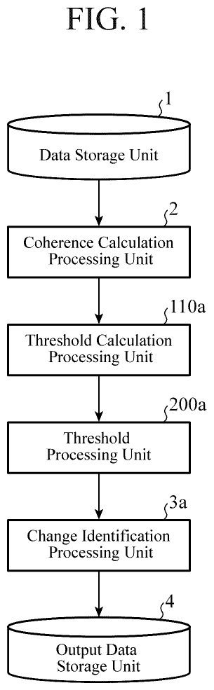

FIG. 1 is a block diagram illustrating a functional configuration of an image processing device according to a first embodiment. As illustrated in FIG. 1, the image processing device according to the first embodiment includes a data storage unit 1, a coherence calculation processing unit 2, a threshold calculation processing unit 110a, a threshold processing unit 200a, a change identification processing unit 3a, and an output data storage unit 4.

The elements with “a” attached to the reference signs, such as the threshold calculation processing unit 110a, the threshold processing unit 200a, and the change identification processing unit 3a, indicate modes in the first embodiment, and modifications thereof will be described in embodiments described later. Elements without an alphabet after the reference numeral are commonly used in the technology according to the present disclosure regardless of embodiments.

### <<Data Storage Unit 1>>

The data storage unit 1 is a component that stores images to be handled by the image processing device. Specifically, the data storage unit 1 stores data (hereinafter referred to as “image data”) related to N images obtained by N observations and imaged at different times. The image handled by the image processing device according to the technology of the present disclosure is assumed to be, for example, a radar image.

The image data stored in the data storage unit 1 can be read from another functional block of the image processing device, for example, the coherence calculation processing unit 2.

### <<Coherence Calculation Processing Unit 2>>

The coherence calculation processing unit 2 is a component that calculates a coherence distribution between images.

The coherence calculation processing unit 2 calculates, as a first step, a complex radar image for each of N radar images that have been read. As a second step, the coherence calculation processing unit 2 generates coherence distributions (hereinafter referred to as “coherence maps”) between complex radar images for all combinations (_{N}C₂ combinations) of two complex radar images extracted from the calculated N complex radar images. The coherence map may also be referred to as a complex correlation distribution. The coherence calculation processing unit 2 generates the coherence map on the basis of each piece of pixel information of the complex radar image.

### <<Threshold Calculation Processing Unit 110>>

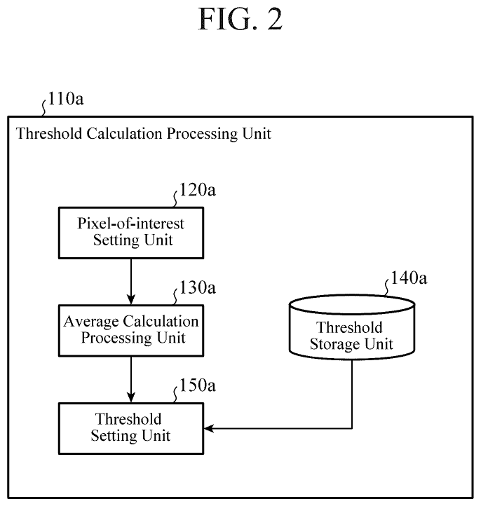

The threshold calculation processing unit 110 is a component that sets a threshold used for extracting a “change region” to be described later. The details of the threshold calculation processing unit 110 will be apparent from the description of FIG. 2 described later.

### <<Threshold Processing Unit 200>>

The threshold processing unit 200 is a component that performs threshold processing using the threshold set by the threshold calculation processing unit 110. The purpose of the threshold processing performed by the threshold processing unit 200 is to determine whether or not a change has occurred in a pixel of interest.

### <<Change Identification Processing Unit 3>>

The change identification processing unit 3 is a component that identifies, when it is determined that a change has occurred in the pixel of interest, the type of the change. The type of the change identified by the change identification processing unit 3 is sent to the output data storage unit 4. The type of the change identified by the change identification processing unit 3 may be programmed to be displayed on a display unit (not illustrated) of the image processing device.

### <<Output Data Storage Unit 4>>

The output data storage unit 4 is a component that stores the type of the change identified by the change identification processing unit 3.

### <<Detail of Processing Performed by Image Processing Device>>

The coherence calculation processing unit 2 included in the image processing device calculates a complex radar image for each of N radar images that have been read as described above. The coherence calculation processing unit 2 then generates coherence maps between complex radar images for all combinations (_{N}C₂ combinations) of two complex radar images extracted from the calculated N complex radar images.

In the present specification, n and m represent sampling numbers related to images. That is, both n and m are natural numbers from 1 to N. The sampling numbers (n and m) related to images may be restated as frame numbers related to images. Note that the radar image assumed by the technology according to the present disclosure is a plurality of radar images obtained by observing the same region at different times. That is, the technology according to the present disclosure assumes a radar image related to a synthetic aperture radar mounted on a flying object (artificial satellite or aircraft) that performs periodic observation a plurality of times. From that point view, the sampling period is on a weekly basis or a monthly basis. Therefore, a moving image created by combining the images is played at much faster speed than the actual speed, although the sampling numbers (n and m) related to images can be considered as the frame numbers related to images.

The sampling period of the radar image handled by the image processing device may be short, for example, on a daily basis or an hourly basis. In such a case, even when two images having adjacent sampling numbers, for example, an nth radar image and an (n+1)th radar image are compared, little change is found. In this case, when the conventional image processing is performed and the coherence of the (n+1)th radar image viewed from the nth radar image is calculated, only coherence close to 1 is uniformly calculated for any pixel.

The technology according to the present disclosure is effective for such a case where the sampling period is short as described above. The image processing device according to the technology of the present disclosure calculates coherences (Cₙ) not only for two images having adjacent sampling numbers but also for two images having sampling numbers which are not consecutive.

As viewed from the radar image (hereinafter simply referred to as “nth radar image”) in the nth sampling, the coherence (Cₙ) with the radar image (hereinafter simply referred to as “mth radar image”) in the mth sampling is given by the following expression.

$$\{ \begin{matrix}for n = 1 to N - 1 \\ and \\ for m = n + 1 to N\end{matrix} \qquad ( 1 )$$

$${C}_{n} ( m , y , x ) = \frac{{\sum }_{i = 1}^{L} {Z}_{n} ( y , x ) {Z}_{m}^{*} ( y , x )}{\sqrt{{\sum }_{i = 1}^{L} {\vert {Z}_{n} ( y , x ) \vert}^{2}} \sqrt{{\sum }_{i = 1}^{L} {\vert {Z}_{m} ( y , x ) \vert}^{2}}}$$

In Expression (1), Zₙ(y, x) represents a value of data (referred to as “data value”) at a position (y, x) in the nth radar image. Similarly, Zₘ(y, x) in Expression (1) is a data value at a position (y, x) in the mth radar image. The parameter L appearing in Expression (1) represents the number of pixels used to calculate the coherences of pixels of interest located at (y, x). In addition, the superscript asterisk (*) appearing in Expression (1) indicates a complex conjugate. In Expression (1), m is a natural number larger than n. When m=n+1, Expression (1) is the same as the expression of coherence according to the related art disclosed in Patent Literature 1.

The coherence (Cₙ) given by Expression (1) is based on the premise that the nth radar image and the mth radar image are acquired in the same satellite orbit. The coherence (Cₙ) has a property of taking a value closer to “1” as a change on the ground surface is smaller, and conversely, taking a smaller value as a change on the ground surface is larger.

In the expression of coherence (Cₙ) given by Expression (1), an operation of obtaining a sum for L pixels is used as a denominator and a numerator. The technology according to the present disclosure may use a result of performing spatial filtering on the L pixels instead of the sum for the L pixels.

Furthermore, in the technology according to present disclosure, a data value (Zₙ(y, x)) at the position (y, x) in the nth radar image may be defined as a ‘result of spatial Fourier transform (for example, in a y direction or an x direction) of L pixels around the position (y, x)’ during calculation of the coherence (Cₙ). In this case, the calculation of the sum in Expression (1) is not performed. In view of this, it can be further understood that Zₙ(y, x) is a complex number. In addition, it can be understood that the coherence (Cₙ) is a complex number on the unit circumference on a complex plane. The detail of a method for calculating the coherence (Cₙ) will be apparent from the description of the sixth embodiment.

As described above, little change is found even when two images having adjacent sampling numbers, for example, an nth radar image and an (n+1)th radar image are compared in a case where the sampling period of the radar image handled by the image processing device is short. An effective way to extract changes is to compare the first image and the last image among images that are chronologically arranged. Therefore, what is important in the coherence (Cₙ) calculated based on Expression (1) is the coherence (C₁(N, y, x)) for the last frame viewed from the first frame. In addition, a method for tracking the coherence (C₁) of the remaining N−1 images using the image on the first frame as a reference image is also effective. This method is effective in identifying a frame in which a change has occurred, that is, a period in which a change has occurred.

The threshold calculation processing unit 110 included in the image processing device sets a threshold used for extracting a “change region” as described above. The thresholds set by the threshold calculation processing unit 110 are denoted as P_{thd} and Pₜₕᵤ in the present specification. Subscripts used for P_{thd} and Pₜₕᵤ are originated from th of “threshold” meaning a threshold, d of “down” meaning down, and u of “up” meaning up.

The threshold calculation processing unit 110 may set P_{thd} and Pₜₕᵤ on the basis of coherences of the adjacent N−1 images, that is, coherences when m=n+1, among the coherences related to the pixel of interest (position (y, x)) calculated by the coherence calculation processing unit 2.

The threshold processing unit 200 included in the image processing device performs threshold processing using the thresholds (P_{thd} and Pₜₕᵤ) as described above. The threshold processing performed by the threshold processing unit 200 is specifically based on the following conditional expression.

TABLE 1
Threshold Processing

| Conditional Expression | Determination Result |
|---|---|
| Cₙ(m, y, x) ≤ P_{thd} | Pixel of Interest is |
| | Change Region |
| P_{thd} < Cₙ(m, y, x) < Pₜₕᵤ | Pixel of Interest is Not |
| | Change Region |
| Pₜₕᵤ ≤ Cₙ(m, y, x) | Pixel of Interest is |
| | Change Region |

Here, the term “pixel of interest” described in Table 1 means the pixel of interest located at (y, x) of the coherence map by the set of the nth radar image and the mth radar image.

As described above, the coherence (Cₙ) is originally a complex number, but as can be seen in the related art disclosed in Patent Literature 1, there is a case where discussion is made focusing only on the real part of the complex number. In the technology according to the present disclosure, the conditional expression shown in Table 1 means that the real part of the complex number is focused on for coherence and compared with a threshold that is a real number.

The threshold processing unit 200 performs the threshold processing shown in Table 1 for the coherence maps of all combinations (_{N}C₂ combinations).

As described above, the coherence (Cₙ) is a complex number on a unit circumference on a complex plane. In addition, the coherence (Cₙ) has a value closer to “1” as a change on the ground surface is smaller. In other words, the real part of the coherence (Cₙ) approaches 1 as there is less change on the ground surface.

In the conditional expression shown in the upper part of Table 1, it is not strange that, when the real part of the coherence (Cₙ) is equal to or less than the lower threshold (P_{thd}), it is determined that “the pixel of interest is a change region”.

The conditional expression shown in the lower part of Table 1 considers regions such as forests and water areas. Regions such as forests and water areas are usually low in coherence (Cₙ) due to the reasons such as branches and leaves being shaken by wind, or waves being generated by wind. The region of forests transitions to a high coherence state from a low coherence state when forests disappear due to logging or the like. The region of water areas transitions to a high coherence state from a low coherence state when the water areas become land due to global warming or the like. Regarding low coherence regions such as forests and water areas, it is concluded that “the regions are change regions” when there is a transition from the low coherence (Cₙ) state to the high coherence (Cₙ) state, that is, when there is any disappearance. The conditional expression shown in the lower part of Table 1 seems to be strange at first glance, but it is not strange in consideration of low coherence regions such as forests and water areas. The upper threshold (Pₜₕᵤ) appearing in the conditional expression in the lower part of Table 1 is also set in consideration of low coherence regions such as forests and water areas.

FIG. 2 is a block diagram illustrating a functional configuration of the threshold calculation processing unit 110a included in the image processing device according to the first embodiment. As illustrated in FIG. 2, the threshold calculation processing unit 110a includes a pixel-of-interest setting unit 120a, an average calculation processing unit 130a, a threshold storage unit 140a, and a threshold setting unit 150a.

The pixel-of-interest setting unit 120a in the threshold calculation processing unit 110a performs processing of selecting a pixel to be used for setting the threshold. The pixel-of-interest setting unit 120a acquires the coherence (Cₙ) given by Expression (1) in chronological order.

The average calculation processing unit 130a in the threshold calculation processing unit 110a performs processing of calculating the coherence of each pixel set by the pixel-of-interest setting unit 120a and further calculating an average value.

The threshold storage unit 140a in the threshold calculation processing unit 110a stores in advance parameters used to calculate the threshold. The parameter used to calculate the threshold is, for example, offset values (Ba and Bu).

The threshold setting unit 150a in the threshold calculation processing unit 110a determines thresholds (P_{thd}, Pₜₕᵤ) to be used for detection on the basis of the average value calculated by the average calculation processing unit 130a and the parameters stored in the threshold storage unit 140a.

The average value (Mc) calculated by the average calculation processing unit 130a is given by the following expression.

$${M}_{c} ( y , x ) = \frac{{\sum }_{n = 1}^{N - 1} {C}_{n} ( n + 1 , y , x )}{N - 1} \qquad ( 2 )$$

Specifically, Expression (2) gives an average value of adjacent N−1 coherences, that is, an average value of coherences when m=n+1, among the coherences related to the pixels of interest (position (y, x)).

The thresholds (P_{thd} and Pₜₕᵤ) determined by the threshold setting unit 150a are given by, for example, the following expression.

$$\{ \begin{matrix}{P}_{thd} = {M}_{c} ( y , x ) - {β}_{d} \\ {P}_{thu} = {M}_{c} ( y , x ) + {β}_{u}\end{matrix} \qquad ( 3 )$$

As represented by Expressions (2) and (3), the image processing device according to the first embodiment sets a region having a width of offset values (β_{d} and βᵤ) set in advance around the average value of the measured N−1 adjacent coherences as a “region that is not a change region”.

The purpose of using the average value in setting the threshold is disclosed in, for example, Patent Literature 1. As disclosed in Patent Literature 1, regions such as forests and water areas originally have low coherence. In order to extract a change in a region originally having low coherence, the image processing device sets a threshold based on an average value of coherences.

In addition, it is considered that the region of forests transitions to a high coherence state from a low coherence state when forests disappear due to logging or the like. Therefore, not only the lower threshold (P_{thd}) but also the higher threshold (Pₜₕᵤ) is set.

As described above, the change identification processing unit 3 identifies, when it is determined that a change has occurred in the pixel of interest, the type of the change. The processing performed by the change identification processing unit 3 is referred to as “change identification” in the present specification. The change identification performed by the change identification processing unit 3 may be executed on the basis of coherences calculated from freely selected three images, that is, a change rate of coherences.

When sampling times are set to n, m₁, and m₂, there are nine possible cases shown in the following table in which the coherence changes from the coherence (Cₙ(m₁)) of the m₁th image viewed from the nth image and the coherence (Cₘ₁(m₂)) of the math image viewed from the m₁th image.

TABLE 2
Nine Cases

| | | P_{thd} < Cₘ_{₁} | Pₜₕᵤ ≤ Cₘ_{₁} |
|---|---|---|---|
| | Cₘ_{₁} (m₂) ≤ P_{thd} | (m₂) < Pₜₕᵤ | (m₂) |
| Cₙ(m₁) ≤ P_{thd} | Case 5 | Case 4 | Case 6 |
| P_{thd} < Cₙ(m₁) < Pₜₕᵤ | Case 2 | Case 1 | Case 3 |
| Pₜₕᵤ ≤ Cₙ(m₁) | Case 8 | Case 7 | Case 9 |

Note that, in Table 2, y and x are omitted in the arguments of the function (Cₙ, Cₘ₁) representing coherence. Similar to m in Expression (1), m₁ and m₂ in Table 2 represent sampling numbers related to images. The magnitude relationship among n, m₁, and m₂ is 1≤n<m₁<m₂≤N.

In the case of Case 1 shown in Table 2, the change identification processing unit 3a according to the first embodiment compares the coherence (Cₙ(m₂)) of the math image viewed from the nth image with the threshold.

TABLE 3
Divided by Cases in Case 1

| Conditional Expression | Determination Result |
|---|---|
| Cₙ(m₂, y, x) ≤ P_{thd} | Case 1B |
| | Gradually Change throughout |
| | Period |
| P_{thd} < Cₙ(m₂, y, x) < Pₜₕᵤ | Case 1A |
| | No Change |
| Pₜₕᵤ ≤ Cₙ(m₂, y, x) | Case 1C |
| | Slight Change in m₁th Image |

Case 1 shown in Table 2 indicates a situation in which there is no change from the nth image to the m₁th image and from the m₁th image to the math image. Table 3 shows a result when a change from the nth image directly to the math image is focused.

The top row of Table 3 indicates that there is a change when a change from the nth image directly to the math image is focused. Therefore, the determination result in this case is that “there is a gradual change throughout the period”.

The middle row of Table 3 indicates that there is no change when a change from the nth image directly to the m₂th image is focused. Therefore, the determination result in this case is that “there is no change”.

The bottom row of Table 3 indicates that the coherence when a change from the nth image directly to the moth image is focused is higher than those of other combinations. That is, this case indicates that there is almost no change between the nth image and the moth image. This phenomenon can occur when a slight change occurs in the m₁th image. Furthermore, this phenomenon indicates that a slight change occurring in the m₁th image is restored up to the math image. Therefore, the determination result in this case is that “there is a slight change in the m₁th image”.

Regarding the pixel of interest, the change identification processing unit 3a performs change identification for a total of eleven types of situations (Case 1A, Case 1B, Case 1C, Case 2, Case 3, Case 4, Case 5, Case 6, Case 7, Case 8, and Case 9) shown in Tables 2 and 3.

As described above, the image processing device according to the technology of the present disclosure can extract a change even in a case where both Cₙ(m₁) and Cₘ₁(m₂) are change regions.

The change identification processing unit 3 executes the change identification for each pixel of interest. The result of the processing performed by the change identification processing unit 3 is stored in the output data storage unit 4. The data stored in the output data storage unit 4 may be a structure. The structure stored in the output data storage unit 4 may include a field for specifying the pixel of interest and a field indicating the change identification obtained by the processing performed by the change identification processing unit 3. The field for specifying the pixel of interest may be specifically the position of the pixel of interest (y, x). The field indicating the change identification obtained by the processing performed by the change identification processing unit 3a may be any field as long as it can identify any of eleven types of situations (Case 1A, Case 1B, Case 1C, Case 2, Case 3, Case 4, Case 5, Case 6, Case 7, Case 8, and Case 9).

As described above, the image processing device according to the first embodiment has the above configuration, and thus, even in a case where only about three to several tens of radar images can be obtained, it is possible to extract a physical change occurred on the ground surface included in the radar images with higher accuracy than before.

### Second Embodiment

An image processing device according to a second embodiment is a modification of the image processing device according to the technology of the present disclosure. Unless otherwise specified, the same reference numerals as those used in the first embodiment are used in the second embodiment. In the second embodiment, the description overlapping with that of the first embodiment will be omitted as appropriate.

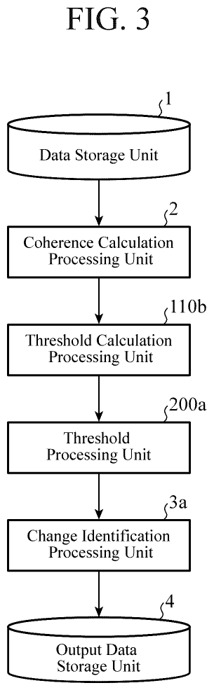

FIG. 3 is a block diagram illustrating a functional configuration of the image processing device according to the second embodiment. As illustrated in FIG. 3, the image processing device according to the second embodiment includes a data storage unit 1, a coherence calculation processing unit 2, a threshold calculation processing unit 110b, a threshold processing unit 200a, a change identification processing unit 3a, and an output data storage unit 4. As described above, the configuration of the image processing device according to the second embodiment is basically the same as that described in the first embodiment. A component with “b” after a reference numeral as in the threshold calculation processing unit 110b indicates a mode in the second embodiment.

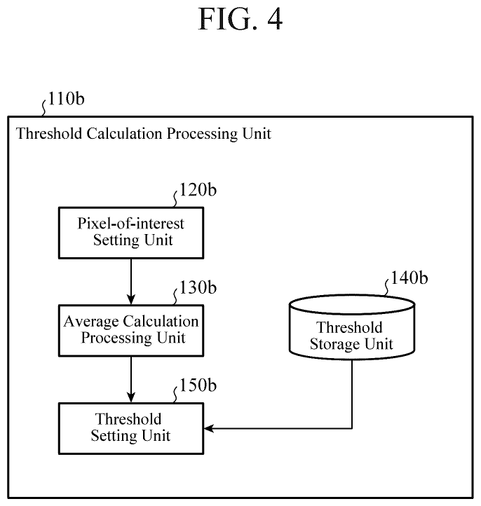

FIG. 4 is a block diagram illustrating a functional configuration of the threshold calculation processing unit 110b included in the image processing device according to the second embodiment. As illustrated in FIG. 4, the threshold calculation processing unit 110b includes a pixel-of-interest setting unit 120b, an average calculation processing unit 130b, a threshold storage unit 140b, and a threshold setting unit 150b.

### <<Average Calculation Processing Unit 130b According to Second Embodiment>>

The average calculation processing unit 130a according to the first embodiment obtains a value given by Expression (2), that is, an average value using only adjacent images, but the technology according to the present disclosure is not limited thereto.

In the image processing device according to the technology of the present disclosure, the average calculation processing unit 130b may use a value given by the following expression.

$${M}_{c \_ 2} ( y , x ) = \frac{{\sum }_{n = 1}^{N - 1} \{ {\sum }_{m = n + 1}^{N} {C}_{n} ( m , y , x ) \}}{{}_{N} {C}_{2}} \qquad ( 4 )$$

Here, _{N}C₂ in the denominator on the right side of Expression (4) is the number of combinations of two images extracted from N images. That is, the average calculation processing unit 130b according to the second embodiment calculates an average value of coherences for all combinations.

### <<Threshold Setting Unit 150b According to Second Embodiment>>

Thresholds (P_{thd_2}, P_{thu_2}) determined by the threshold setting unit 150b are given by, for example, the following expression.

$$\{ \begin{matrix}{P}_{thd \_ 2} = {M}_{c \_ 2} ( y , x ) - {β}_{d} \\ {P}_{thu \_ 2} = {M}_{c \_ 2} ( y , x ) + {β}_{u}\end{matrix} \qquad ( 5 )$$

As represented by Expressions (4) and (5), the image processing device according to the second embodiment sets a region having a width of offset values (β_{d} and βᵤ) set in advance around the average value of coherences calculated for all of the combinations as a “region that is not a change region”.

As described above, the image processing device according to the second embodiment has the above configuration, and thus, the same effects as those of the image processing device according to the first embodiment are obtained.

### Third Embodiment

An image processing device according to a third embodiment is a modification of the image processing device according to the technology of the present disclosure. Unless otherwise specified, the same reference numerals as those used in the above-described embodiments are used in the third embodiment. In the third embodiment, the description overlapping with those of the above-described embodiments will be omitted as appropriate.

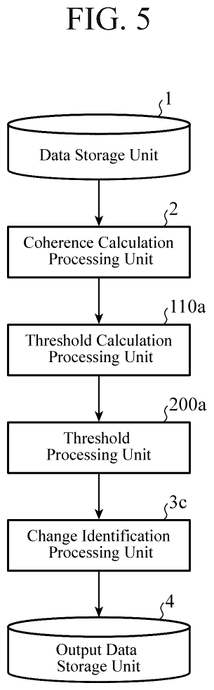

FIG. 5 is a block diagram illustrating a functional configuration of the image processing device according to the third embodiment. As illustrated in FIG. 5, the image processing device according to the third embodiment includes a data storage unit 1, a coherence calculation processing unit 2, a threshold calculation processing unit 110a, a threshold processing unit 200a, a change identification processing unit 3c, and an output data storage unit 4. As described above, the configuration of the image processing device according to the third embodiment is basically the same as that described in the first embodiment. A component with “c” after a reference numeral as in the change identification processing unit 3c indicates a mode in the third embodiment.

### <<Change Identification Processing Unit 3c According to Third Embodiment>>

The change identification processing unit 3a according to the first embodiment has first defined nine cases (Case 1, Case 2, Case 3, Case 4, Case 5, Case 6, Case 7, Case 8, and Case 9) shown in Table 2 from the coherence (Cₙ(m₁)) of the m₁th image viewed from the nth image and the coherence (Cₘ₁(m₂)) of the moth image viewed from the m₁th image. The change identification processing unit 3a according to the first embodiment has further defined three types of Case 1 (Case 1A, Case 1B, and Case 1C) from the coherence (Cₙ(m₂)) of the moth image viewed from the nth image.

The change identification processing unit 3c according to the third embodiment compares the coherence (Cₙ(m₁)) of the meth image viewed from the nth image with a threshold for all of the nine cases (Case 1, Case 2, Case 3, Case 4, Case 5, Case 6, Case 7, Case 8, and Case 9) shown in Table 2, and has further defined three types of each of nine cases, that is, defined a total of 9×3=27 cases.

As described above, the change identification processing unit 3 executes the change identification for each pixel of interest. The result of the processing performed by the change identification processing unit 3 is stored in the output data storage unit 4. The data stored in the output data storage unit 4 may be a structure. The structure stored in the output data storage unit 4 may include a field for specifying the pixel of interest and a field indicating the change identification obtained by the processing performed by the change identification processing unit 3. The field for specifying the pixel of interest may be specifically the position of the pixel of interest (y, x).

The field indicating the change identification obtained by the processing performed by the change identification processing unit 3c may be any field as long as it can identify any of 27 types of situations.

As described above, the image processing device according to the third embodiment has the above configuration, and thus, the same effects as those of the image processing devices according to the above-described embodiments are obtained.

### Fourth Embodiment

An image processing device according to a fourth embodiment is a modification of the image processing device according to the technology of the present disclosure. Unless otherwise specified, the same reference numerals as those used in the above-described embodiments are used in the fourth embodiment. In the fourth embodiment, the description overlapping with those of the above-described embodiments will be omitted as appropriate.

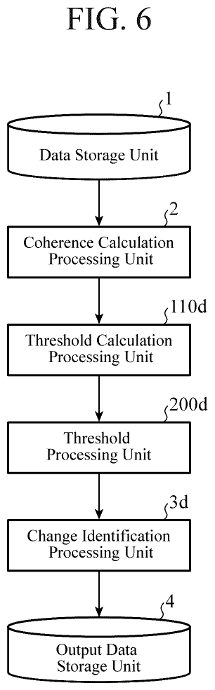

FIG. 6 is a block diagram illustrating a functional configuration of the image processing device according to the fourth embodiment. As illustrated in FIG. 6, the image processing device according to the fourth embodiment includes a data storage unit 1, a coherence calculation processing unit 2, a threshold calculation processing unit 110d, a threshold processing unit 200d, a change identification processing unit 3d, and an output data storage unit 4. As described above, the configuration of the image processing device according to the fourth embodiment is basically the same as that described in the first embodiment. A component with “d” after a reference numeral as in the change identification processing unit 3d indicates a mode in the fourth embodiment.

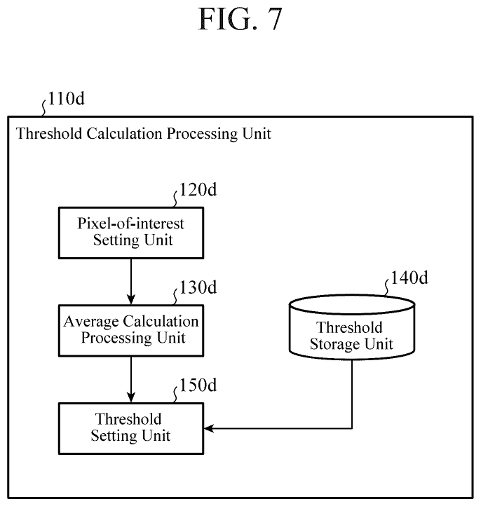

FIG. 7 is a block diagram illustrating a functional configuration of the threshold calculation processing unit 110d included in the image processing device according to the fourth embodiment. As illustrated in FIG. 7, the threshold calculation processing unit 110d includes a pixel-of-interest setting unit 120d, an average calculation processing unit 130d, a threshold storage unit 140d, and a threshold setting unit 150d.

The image processing device according to the technology of the present disclosure may simultaneously include the mode described in the second embodiment and the mode described in the third embodiment. In the image processing device according to the fourth embodiment, the average calculation processing unit 130d performs the processing given by Expression (4) and calculates the average value of coherences for all combinations. In addition, the change identification processing unit 3d of the image processing device according to the fourth embodiment compares the coherence (Cₙ(m₂)) of the m₂th image viewed from the nth image with a threshold for all of the nine cases (Case 1, Case 2, Case 3, Case 4, Case 5, Case 6, Case 7, Case 8, and Case 9) shown in Table 2, and has further defined three types of each of nine cases, that is, defined a total of 9×3=27 cases.

As described above, the image processing device according to the technology of the present disclosure is not limited to the aspects described in the respective embodiments, and it is possible to combine the respective embodiments, to modify any component of the respective embodiments, or to omit any component in the respective embodiments.

As described above, the image processing device according to the fourth embodiment has the above configuration, and thus, the same effects as those of the image processing devices according to the above-described embodiments are obtained.

### Fifth Embodiment

An image processing device according to a fifth embodiment is a modification of the image processing device according to the technology of the present disclosure. Unless otherwise specified, the same reference numerals as those used in the above-described embodiments are used in the fifth embodiment. In the fifth embodiment, the description overlapping with those of the above-described embodiments will be omitted as appropriate.

The image processing device described in each of the first to fourth embodiments calculates an average value of coherences by the average calculation processing unit 130, and sets a region having a width of offset values (Ba and Bu) set in advance around the calculated average value as a “region that is not a change region” by the threshold setting unit 150.

The image processing device according to the technology of the present disclosure is not limited to using preset offset values (Ba and Bu).

The image processing device according to the fifth embodiment may refer to a theoretical dispersion value or a false-alarm probability instead of the preset offset values (Ba and Bu) when setting the “region that is not the change region”.

As described above, the image processing device according to the fifth embodiment has the configuration described above, and thus, provides an effect of being capable of increasing a degree of freedom regarding the setting of the “region that is not the change region” in addition to the effects similar to those of the image processing devices according to the above-described embodiments.

### Sixth Embodiment

An image processing device according to a sixth embodiment is a modification of the image processing device according to the technology of the present disclosure. Unless otherwise specified, the same reference numerals as those used in the above-described embodiments are used in the sixth embodiment. In the sixth embodiment, the description overlapping with those of the above-described embodiments will be omitted as appropriate.

In the image processing device according to the technology of the present disclosure, a radar image to be processed may be treated in advance or may be untreated. The image processing device according to the sixth embodiment performs pre-processing treatment on a radar image.

As described above, in the technology according to present disclosure, the data value (Zₙ(y, x)) at the position (y, x) in the nth radar image may be defined as a ‘result of spatial Fourier transform (for example, in a y direction or an x direction) of L pixels around the position (y, x)’ during calculation of the coherence (Cₙ). Zₙ(y, x) may be, for example, a value given by the following expression.

$${Z}_{n} ( y , x ) = α + j β$$

wherein

$$α = \frac{2}{π} {\sum }_{k = y - \frac{{L}_{2}}{2}}^{y + \frac{{L}_{2}}{2}} b ( k , x ) cos ( \frac{k - y}{{L}_{2} + 1} π ) \qquad ( 6 )$$

$$β = \frac{2}{π} {\sum }_{k = y - \frac{{L}_{2}}{2}}^{y + \frac{{L}_{2}}{2}} b ( k , x ) sin ( \frac{k - y}{{L}_{2} + 1} π )$$

Here, L₂ in Expression (6) corresponds to L in Expression (1). Expression (6) is a result of Fourier transform of L₂+1 pixels around the position (y, x) in the y direction, more precisely, a result of transform by a description function. In Expression (6), b (y, x) represents the luminance of the pixel at the position (y, x). In Expression (6), j represents an imaginary number. Although Expression (6) represents the Fourier transform in the y direction, the Fourier transform in the x direction may be used.

When a certain radar image is focused, a dark portion and a light portion of pixels may periodically appear in a specific region such as forests when viewed spatially. For example, it is assumed that, in a forest region in a radar image, the luminance of pixels is high at an interval of five pixels. In such a case, when the conversion of Expression (6) is performed on the radar image with L=4, the absolute value of Zₙ(y, x) (the distance from the origin on the complex plane) is large in the region where the luminance is high at an interval of five pixels. In this way, the technology according to the present disclosure may extract a region that is of interest (hereinafter referred to as “region of interest”).

Expression (6) is an example of the pre-processing treatment on the radar image. When L₂=0 in Expression (6), Zₙ(y, x) is equal to b (y, x) multiplied by π/2, which is equivalent to the situation in which the pre-processing treatment is not performed.

When Zₙ(y, x) is given by Expression (6), the coherence (Cₙ) is given as follows.

$$\{ \begin{matrix}for n = 1 to N - 1 \\ and \\ for m = n + 1 to N\end{matrix} \qquad ( 7 )$$

$${C}_{n} ( m , y , x ) = \frac{{Z}_{n} ( y , x ) {Z}_{m}^{*} ( y , x )}{\vert {Z}_{n} ( y , x ) \vert \vert {Z}_{m} ( y , x ) \vert}$$

The coherence (Cₙ) between images having no change can be derived from Expressions (6) and (7). The coherence (Cₙ) between images having no change can be calculated as the coherence (Cₙ) of the nth radar image viewed from the nth radar image as follows.

$$\begin{matrix}{C}_{n} ( m , y , x ) = \frac{{Z}_{n} ( y , x ) {Z}_{n}^{*} ( y , x )}{\vert {Z}_{n} ( y , x ) \vert \vert {Z}_{n} ( y , x ) \vert} \\ = \frac{( α + β j ) ( α - β j )}{\sqrt{{α}^{2} + {β}^{2}} \sqrt{{α}^{2} + {β}^{2}}} \\ = \frac{{α}^{2} + {β}^{2}}{{α}^{2} + {β}^{2}} \\ = 1\end{matrix} \qquad ( 8 )$$

In a case where the coherence (Cₙ) of the m₁th radar image viewed from the nth radar image and the coherence (Cₙ) of the math radar image viewed from the m₁th radar image are given, the coherence (Cₙ) of the m₂th radar image viewed from the nth radar image is given as follows.

$$\begin{matrix}{C}_{n} ( {m}_{2} , y , x ) = \frac{{Z}_{n} ( y , x ) {Z}_{{m}_{2}}^{*} ( y , x )}{\vert {Z}_{n} ( y , x ) \vert \vert {Z}_{{m}_{2}} ( y , x ) \vert} \\ = \frac{{Z}_{n} ( y , x ) {Z}_{{m}_{2}}^{*} ( y , x )}{\vert {Z}_{n} ( y , x ) \vert \vert {Z}_{{m}_{2}} ( y , x ) \vert} {\overbrace{\{ \frac{{Z}_{{m}_{1}} ( y , x ) {Z}_{{m}_{1}}^{*} ( y , x )}{\vert {Z}_{{m}_{1}} ( y , x ) \vert \vert {Z}_{{m}_{1}} ( y , x ) \vert} \}}}^{= 1} \\ = \frac{{Z}_{n} ( y , x ) {Z}_{{m}_{1}}^{*} ( y , x )}{\vert {Z}_{n} ( y , x ) \vert \vert {Z}_{{m}_{1}} ( y , x ) \vert} \frac{{Z}_{{m}_{1}} ( y , x ) {Z}_{{m}_{2}}^{*} ( y , x )}{\vert {Z}_{{m}_{1}} ( y , x ) \vert \vert {Z}_{{m}_{2}} ( y , x ) \vert} \\ = {C}_{n} ( {m}_{1} , y , x ) {C}_{{m}_{1}} ( {m}_{2} , y , x )\end{matrix} \qquad ( 9 )$$

As an example of the pre-processing treatment, Expression (6) related to the spatial Fourier transform is indicated, but the technology according to the present disclosure is not limited thereto. The image processing device according to the technology of the present disclosure may perform temporal Fourier transform instead of Expression (6). More specifically, the image processing device according to the technology of the present disclosure may, for example, divide radar images for each season to be observed, perform temporal Fourier transform on the radar images for each season, and perform comparison between seasons.

The image processing device according to the technology of the present disclosure may be applied to a treated image on which semantic segmentation that is a deep learning algorithm has been performed. The image processing according to the technology of the present disclosure can also be used together with semantic segmentation.

The image processing device according to the technology of the present disclosure is not limited to be applied to semantic segmentation, and may be applied to an intermediate product of a learning model related to artificial intelligence such as a neural network, for example, a feature-value map. The image processing according to the technology of the present disclosure can also be used together with artificial intelligence.

As described above, the image processing device according to the sixth embodiment has the above configuration, and thus, provides the same effects as those of the image processing devices according to the above-described embodiments.

### INDUSTRIAL APPLICABILITY

The technology of the present disclosure can be applied to an image processing device that processes a radar image of a ground surface obtained by observation by a synthetic aperture radar that performs periodic observation, and is industrially applicable.

### REFERENCE SIGNS LIST

1: data storage unit, 2: coherence calculation processing unit (coherence calculator), 3: change identification processing unit (change identifier), 4: output data storage unit, 110: threshold calculation processing unit (threshold calculator), 120: pixel-of-interest setting unit (pixel-of-interest setting section), 130: average calculation processing unit (average calculator), 140: threshold storage unit, 150: threshold setting unit (threshold setting section), 200: threshold processing unit (threshold processor).

What is claimed is:

1. An image processing device comprising:
a coherence calculator to calculate a coherence map for all combinations of images, choosing two from the total number;
a threshold calculator to set a threshold used to extract a change region;
a threshold processor to perform threshold processing on the coherence map using the threshold; and
a change identifier to determine which of at least nine different modes of coherence change occurs by referring to the coherence maps calculated by the coherence calculator for two combinations of images, two of which are extracted from at least three images, and to identify the type of change when it is determined that a change has occurred in the pixel of interest through the threshold processing;
wherein,
the coherence calculator, when calculating coherence, uses a value obtained by spatially Fourier transforming L pixels centered on a position (y, x) in place of a data value (Zₙ(y, x)) at the position (y, x) in the radar image.

2. The image processing device according to claim 1, wherein
the threshold calculator includes:
a pixel-of-interest setting section to set the pixels of interest;
an average calculator to calculate coherence of each of the pixels of interest and calculate an average value; and
a threshold setting section to set the threshold on a basis of the average value calculated by the average calculator.

3. The image processing device according to claim 2, wherein
the average value calculated by the average calculator is the average value of the coherence between all combinations of images in which two images are extracted from the total number.
